(19) United States
(12) Patent Application Publication
(10) Pub. No.: US 2013/0173459 A1
(43) Pub. Date: Jul. 4, 2013

(54) GIFT CARD CODE INFORMATION AND DISTRIBUTION SYSTEM AND METHODS

(71) Applicant: Array Card, Inc., West Chicago, IL (US)

(72) Inventor: Thomas A. Simonian, Geneva, IL (US)

(73) Assignee: ARRAY CARD, INC., West Chicago, IL (US)

(21) Appl. No.: 13/680,332

(22) Filed: Nov. 19, 2012

Related U.S. Application Data
(63) Continuation-in-part of application No. 13/154,701, filed on Jun. 7, 2011.

(51) Int. Cl. G06Q 20/34

(52) U.S. Cl. CPC G06Q 20/3433
USPC 705/39

(57) ABSTRACT

Information sharing enhances the utility and effectiveness of gift-card transactions. A website enables a user to purchase or activate gift cards and compile recipient contact information to establish a gift network of the gift recipients. Information may be entered in relation to the interests or preferences of the gift recipients in the gift network. Product brands, services or merchants may be recommended to the user, and the user may be made aware of events, deals or promotions related to the interests and preferences of potential recipients in the gift network. Gift-related codes may be disseminated, and gift cards distributed, in accordance with numerous disclosed process flows including “social gifting” processes wherein codes are delivered directly or wherein real or virtual greeting cards are activated on-line and/or at point-of-sale (POS) location(s).

### REFERENCE TO RELATED APPLICATION

This application is a continuation-in-part of U.S. patent application Ser. No. 13/154,701, filed Jun. 7, 2011, the entire content of which is incorporated herein by reference.

### FIELD OF THE INVENTION

This invention relates generally to gift cards and, in particular, to an information sharing system and methods to enhance the utility and effectiveness of such cards.

### BACKGROUND OF THE INVENTION

A “gift card” may be defined as a preloaded debit card that allows a user to purchase goods or services. Some gift cards can only be used at select retailers, while others can be used where major credit cards are accepted. In either case the giver would buy the gift card (and may have to pay an additional purchase fee), and the recipient of the card would use the value of the card at a later transaction. Some gift cards may also be reloadable, which provides the cardholder with the ability to add funds to continue using the card.

Gift cards have become enormously popular because they relieve the donor of selecting a specific gift, and allow the recipient to use the card at his or her discretion within the restrictions set by the issuing agency. Gift cards now rank as the second-most given gift by consumers in the United States (2006) and the most-wanted gift by women, and the third-most wanted by men. The total gift card market in the U.S. now exceeds $100 billion.

A gift card, which typically resembles a credit or debit card, is identified by a specific number or code as opposed to an individual's name. As such they can be used by anybody. Each card usually has a barcode or a magnetic strip which is read by an electronic credit card machine that interfaces with an on-line electronic system for authorization.

Many cards have no value until they are sold, at which time the cashier enters the amount which the customer wishes to put on the card. This amount is rarely stored on the card but is instead noted in the store's database, which is crosslinked to the card ID. Gift cards thus are generally not stored-value cards as used in many public transport systems or library photocopiers, where a simplified system (with no network) stores the value only on the card itself. To thwart counterfeiting, the data is encrypted. The magnetic strip is also often placed differently than on credit cards, so they cannot be read or written with standard equipment. Other gift cards may have a set value and need to be activated by calling a specific number.

Gift cards can also be custom tailored to meet specific needs. By adding a custom message or name on the front of the card, it can make for an individualized gift or incentive to an employee to show how greatly they are appreciated. Some companies offer custom designs on the cards for businesses wishing to add their logo. Special order cards are available for many businesses.

Gift cards are divided into “open-loop” or “network” cards and “closed-loop” cards. The former are issued by banks or credit card companies and can be generally redeemed at any establishment that accepts a credit card. Closed-loop cards can only be redeemed at a specific chain of stores or restaurants, and can be only redeemed by the issuing provider. A third form is the “hybrid closed loop” card where the issuer has bundled a number of closed loop cards; an example is a gift card for a specific mall.

Mobile gift cards are delivered to mobiles phones via SMS messages and phone applications including iphone applications, allowing users to carry only their cell phones. Benefits include tying them to a particular phone number and ease of distribution through email. Virtual gift cards are delivered via e-mail to their recipient, the benefits being that they cannot be lost and that the consumer does not have to drive to the bricks and mortar location to purchase a gift card.

Gift cards have been criticized for rules involving expiration dates, administrative fees, restrictions in use, and absence of adequate protection in case of fraud or loss. Laws have been enacted to protect consumers in this regard, and most merchants have adopted a “no fee, no expiration” policy for their gift cards, whether or not state laws require it.

Some people feel that the absence of the thought in selecting a gift makes a gift card an impersonal choice. As a result, new services launched by some service providers allows for customization and personalization of gift cards. Gift-card brokering services have also evolved enabling customers to buy or sell their pre-owned gift cards. Buyers would typically buy these pre-owned gift cards anywhere from 3-30% off while sellers would sell their pre-owned gift cards for 50-80% of their face value. Third party gift card sites have also emerged along with price comparison websites that allow shoppers to compare how much each of the coupon resellers are buying and selling cards for, thus adding further competition and choice to the discount gift card market.

An example of a third-party gift card provider is www.arraycard.com. The system and method enable a user to purchase a generic Array Card™ which can be redeemed for another gift card of choice, thereby combining the advantages of gift-card giving, but with recipient-controlled redemption. The system currently supports the conversion of an Array Card to over 500 different site-specific gift cards.

There are two ways to give an Array Card, as shown in FIG. 1. The first is to activate a physical Array Card 102 which is obtained from a store and loaded with value. The other method involves the purchase of an ‘Instant Array’—a virtual Array Card that can be printed immediately from the web site 106 or pre-activated as a physical Array Card 104 sent in the mail. The activated Array Card is then redeemed at the location favored by the recipient. Array card activation is carried out by completing a multi-digit code on the back of the card. A first portion of the code 110 is pre-printed, with the remainder of the code 112 being obtained on the Array Card website.

### SUMMARY OF THE INVENTION

This invention is broadly directed to an information sharing system and methods for enhancing the utility and effectiveness of gift cards. In accordance with a method aspect of the invention, a website is established enabling a user to purchase or activate gift cards for gift recipients. Access to a search engine is provided on the website enabling the user to compile recipient contact information and establish a gift network of the gift recipients.

Information may be entered by the user at the website related to the interests or preferences of the gift recipients in the gift network. Product brands, services or merchants may be recommended to the user, or the user may be made aware of events, deals or promotions related to the interests and preferences. Overall, the user is able to make a more informed choice regarding the purchase or activation of gift cards for recipients in the user's gift network, and manufacturers and merchants are provided with more effective advertising and selling tools.

The step of recommending product brands, services or merchants may include the step of providing direct access to one or more databases maintained by product manufacturers or merchant sellers. The step of recommending deals or promotions related to the interests and preferences of the gift recipients may include the step of providing manufacturers or merchants direct access to the network of gift recipients. The method may include the step of determining a monetary valuation of the gift network.

The step of entering information by the user may be preceded by the step of asking the user a series of questions relating to the interests or preferences of the gift recipients in the gift network. In accordance with preferred embodiments, the invention includes the purchase or activation of a generic gift card that may be converted into a gift card intended for a specific product, merchant or purpose.

There are numerous ways in which gift-related codes may be disseminated, and gift cards distributed, in accordance with the invention. Various embodiments are described involving a “social gifting” processes, including flows wherein greeting cards are activated on-line and/or at point-of-sale (POS) location(s).

### BRIEF DESCRIPTION OF THE DRAWINGS

FIG. 1 is a diagram that outlines processes associated with the Array gift card;

FIG. 2 is a table which lists functions, activities and technologies underlying the capabilities of the invention;

FIG. 3 is a diagram illustrating a proprietary data exchange and enabling platform used to build a customer's gift-giving network;

FIG. 4 is a screen display of the Array Card website used by a customer to sign up for the system;

FIG. 5 is a screen display showing the way in which a user builds a gift network;

FIG. 6, shows how a hypothetical customer searches for gift ideas;

FIG. 7 is a screen display that provides a user with questions to obtain further information that may be of benefit to a gift giving experience;

FIG. 8 presents a gift network stimulus;

FIG. 9 illustrates how a user decides to perform a gift search in conjunction with a personalized gift network;

FIG. 10 is a chart showing the way in which a personalized gift network may be given a monetary valuation;

FIG. 11 is a flow diagram that depicts a “social gifting” process flow;

FIG. 12 illustrates a process flow wherein greeting cards are activated on-line; and

FIG. 13 shows the way in which greeting cards may be activated at a point-of-sale (POS) location.

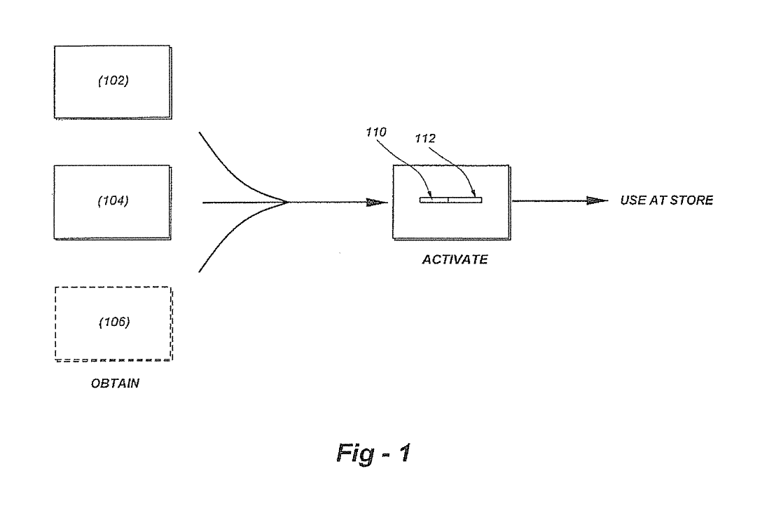

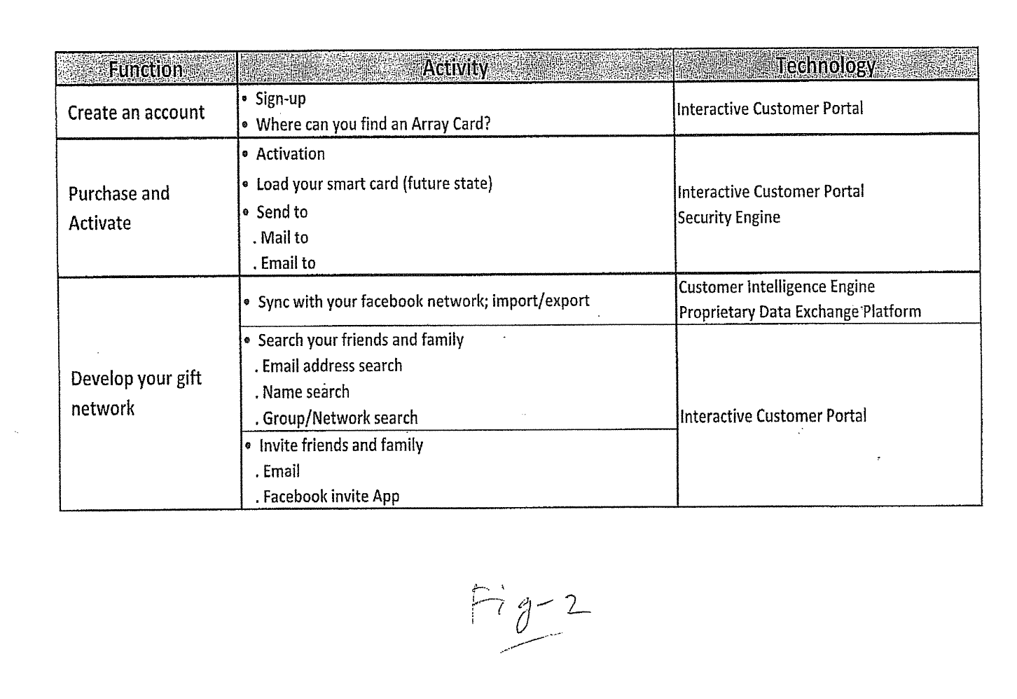

### DETAILED DESCRIPTION OF THE INVENTION

This invention resides in an information-sharing system and methods geared toward enhancing the utility and effectiveness of gift cards. While a “third-party” gift card provider will be used as an example, those of skill in the art will appreciate that the following disclosure applies equally well to non-third-party mechanisms.

The invention takes advantage of a data exchange and engagement platform to manage business intelligence, customer relationships and analytics functionality. The methods broadly use personal valuation tools and multilayer data aggregation to exploit a gift-card customer's network of gift recipients and other information spaces.

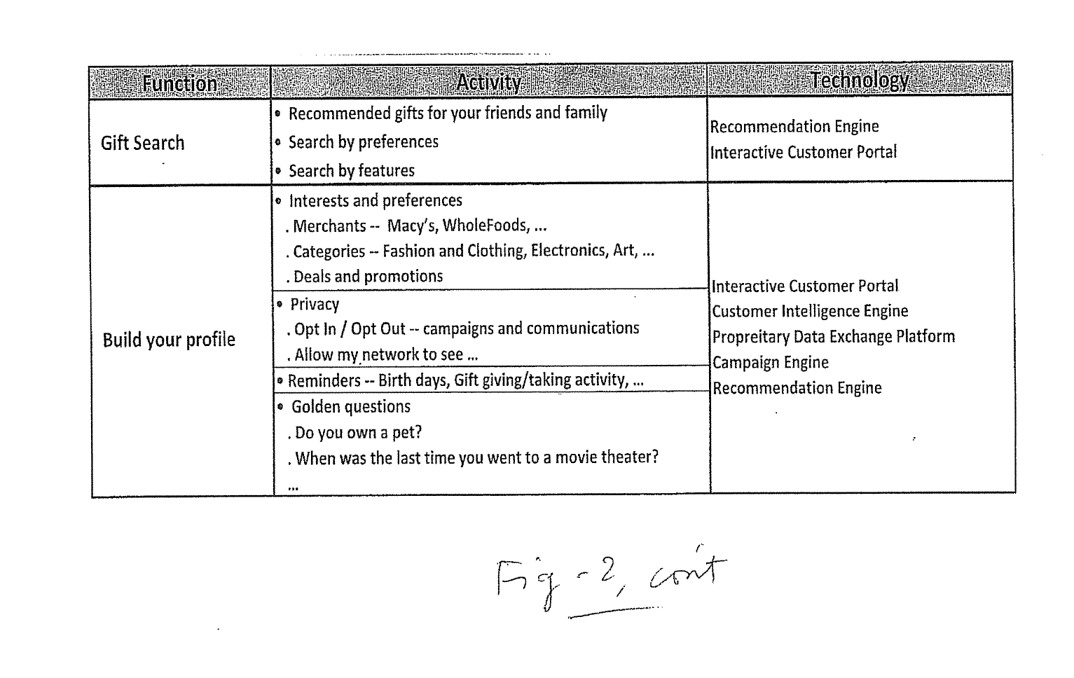

FIG. 2 is a table which lists functions, activities and technologies underlying the capabilities of the invention. In creating an account, a user “Julie” signs up for the services on line through an interactive customer portal. At this point Julie enters certain information, certain of which is inherently valuable, and receives information, including places where the Array Card may be obtained.

Continuing to use the interactive customer portal with enhanced security features, the user purchases and activates the gift card, providing monetary preloading amounts, mailing and email addresses.

As part of the invention, a personalized gift network is developed which provides a customer intelligence engine and proprietary data exchange platform. As part of this enhanced capability, information may be synchronized and shared with social networking sites such as Facebook. This, in turn, allows keyword searching based upon friend/family names, email addresses, social groups and networks. This allows Julie to invite friends and family to join her gift-giving network through the interactive customer portal.

Continuing the reference to FIG. 2, a “recommendation engine” allows Julie to search by preference, features, and other criteria to recommend gifts for friends and family. Using all of the technological tools available, Julie can built a profile oriented around her gift-card network. A database of interests and preferences may be compiled involving preferred merchants, shopping categories, deals and promotions. To ensure privacy, the user will be given the choice to opt in/out of campaigns and other communications associated with the programs offered.

To further enhance gift-related activities, information may be compiled regarding important dates and other milestones related to gift giving and receiving. Questions may be asked and answered to narrow down lifestyle profiles and better target desirable products and services.

Based upon the information collected, notifications may be provided involving important events, deals, promotions, and (seemingly) random opportunities. For example, Julie may be “warned” that her friend “Sue” has a birthday coming up, but due to the crosslinking of available information, the data exchange platform may already “know” what kind of gift cards or opportunities Sue already has and/or what might compliment Sue's existing situation. Other marketing communications might involve time-sensitive promotions or, based upon previous card usages and/or purchases, additional gift cards or complimentary loading of existing cards may be possible.

As a more specific example, assume in this case that Julie has 17 people loaded in her profile, and that these represent the individuals that she buys gifts for over the course of a year. Some of those 17 people may also have a network loaded with and a profile developed through the Array Card proprietary data exchange platform. As such, the system is now able to aggregate data about the purchases of this entire group, the brands that they prefer to buy or that they actually have purchased, and location of those purchases. From the layered data available, the invention facilitates the construction of valuation models, lifetime value profiles, brand preference reports, and potential value reports. In each case, the shared information may be subject to an opt-in platform to obtain appropriate permission levels.

The resultant reporting potential report is very valuable in terms of the future purchases and “share of wallet.” For example, assume that “Julie” has 2 years of experience with the system and/or method. It may therefore be “known” that in the category of home improvement that Julie spends $200 a year in gifts for home improvement to their gift-giving network. As such it is also known that in the home improvement category (from available third-party data), that consumers with a similar profile actually spend upwards of $600 a year. So it can be surmised that the system potentially controls a 33% “share of wallet” of Julie in the home improvement gift giving category. In answering the question: “how can we capture 100% of Julie's spending on home improvement?” This represents an actionable item from a campaign management and from a customer relationship management perspective.

Based upon the developed models, the system is able to determine Julie's “value” after a year or other experience time-frame. If Julie spends $2,000 in gifts for the 17 individuals loaded in her profile, the system knows Julie's value and potential profitability across all those gifts and her average “yield per purchase” in terms of profit or gross margin. Such discrete data elements can be used to compare Julie to other customers in the user database to rate and categorize other customers in terms of their relative value in conjunction with any other available psychographic and demographic variables. This all leads to a perceived value of “Julie” and her network. That is, rather than Julie just being worth the $2,000 that she spends on others, it can be determined that she is worth much more when her entire gifting network is taken into account. If her friends and family have spent a total of $65,000 with the Array Card, for example, her “net worth” is really more like $67,000.

In addition to perceived net worth, a secondary measurable is the annualized revenue and potential profitability from Julie and her network. Indeed, a lifetime value of Julie and her network may be estimated. For example, using 20 years as a lifetime value and discounting using an MPV model of her calculated future value, it can be assumed that Julie's gift network is now worth $7,000,000 over its “lifetime.” So if we keep Julie intact and all of her 17 gift recipients intact as customers of the Array Card, one can value the group and aggregate future value and lifetime value by other variables such as brand. That level of detail and data aggregation across the entire platform and the ability to score that over a future number of time periods results in a very versatile system and method of valuable to the primary user, the user's network, and the merchants and financial institutions that provide goods and services for the entire group.

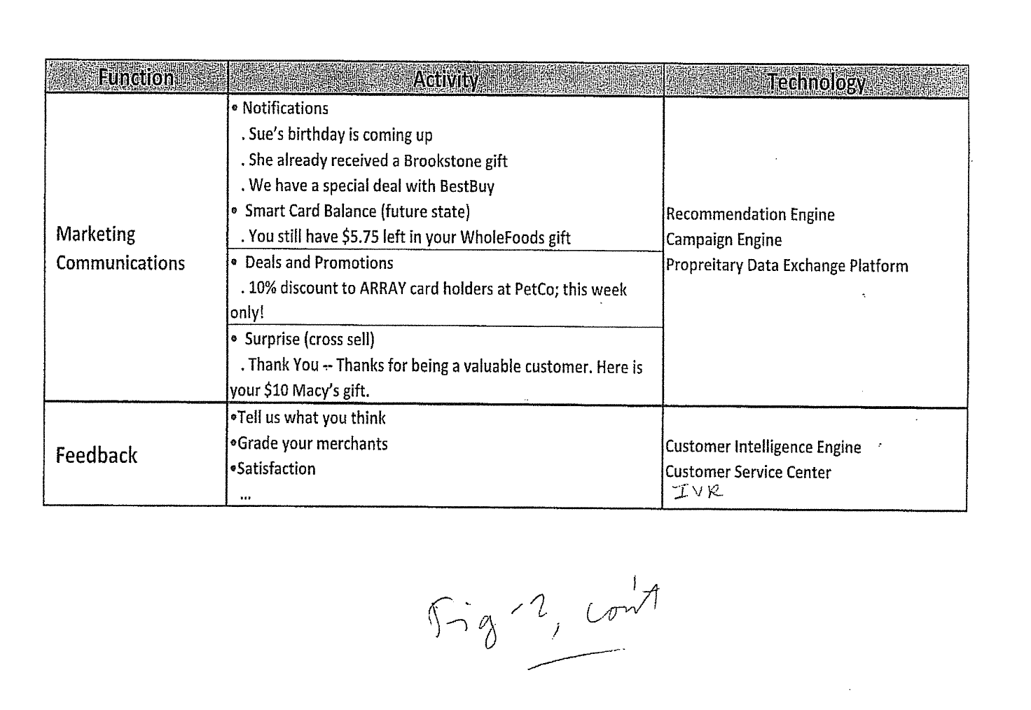

Referring now to FIG. 3, the proprietary data exchange and enabling platform is used to build a customer network in general, but more particularly, to develop detailed and useful characteristics associated with a customer's gifting network. In other words, this is not only Julie's profile, it also characterizes Julie's network, the various people she's got in her network plus their value, how much they've all spent (with the Array Card, for example), the potential value and share of wallet.

Other important information includes merchant information; namely, manufacturers, brands, store operations and business-to-business data. The right-hand side of FIG. 3 depicts the merchant's database. Using the Target store chain as an example, this particular retailer has a database of its customers, too. Like other merchants, Target tracks various information about its customers, including their shopping behavior, their purchase behavior, their product or category affinities, and payment preferences. Also of interest are the manufacturers of the goods that go on Target's shelves. An important aspect of this invention is to connect these three networks for a symbiotic result; that is, connecting a gift card network database(s) with merchant network database(s) with the consumer packaged goods (CPG) and/or original equipment manufacturer (OEM) network database(s).

Thus, an important aspect of the invention is to integrate data with merchants, manufacturers and suppliers to develop a unique modeling capability for consumers—a modeling capability based on gift card transactions that potentially involves a gift card purchaser, the purchaser's network of friends and family, and networks of the purchaser's gift-card recipients, and the networks and databases of the merchants who provide the goods and services made possible by the gift card transactions.

Let's assume that our hypothetical customer lives in Ann Arbor, Mich., and that 8 of the 17 people in her network reside elsewhere in the United States. There is a Target store in Ann Arbor, and whenever Julie buys Array gift cards for 4 people in her network, they decide to redeem them at Target for Target store gift cards. The system and method now knows that each recipient purchased a $50 Target gift card which each purchased with the Array Card. In accordance with the invention, the merchant may now be involved. When the Target card holders redeem their cards, Target's data shows what SKU the consumer bought, when they bought it, and so forth. All available information is pulled together to make intelligent decisions about the customer or decisions about the product or decisions about their purchasing behavior.

The value of this integrated data system can be leveraged in a variety of useful ways. For example, when Julie engages in the process of selecting a closed loop gift card through the redemption of an Array Card, targeted offerings including discounts, premiums; as well as merchant, CPG and OEM coupons and special offers, can be bundled with the gift card. This enables a much more dynamic marketing strategy and provides more value to the consumer than currently exists. For example, Julie's selection of a closed-loop gift card can be influenced by offering her a coupon on a particularly product that she previously purchased at Target if she selects the Target gift card. Julie could also be offered a premium closed loop gift card, e.g., a $30 closed loop gift card in exchange for a $25 Array Card for a particular type of restaurant based on previous purchasing decisions contained within the database.

For a more specific example, assume Julie came into the network and bought a gift card for her husband, John. John then logged on to the Array card website and bought a Target card. By combining the gift card purchaser/recipient friends and family network databases with merchant network database information, an advance notice may be communicated to Target that John will be coming there to shop And there may now be statistics to show when Julie's husband redeems a $50 Target gift card he usually goes shopping within 30 days. Now Target can take that information and encourage John to redeem his gift card quicker. One reason why a store may wish to expedite the transaction is that under GAAP rules a store value card does not constitute revenue for accounting purposes until a customers actually shows up at the store and spends the value represented by the card.

Because the gift card database is interconnected with the merchant's database, new customer management capabilities are made possible, including campaign management and valuation. Shopping behavior as well as product and category level affinity can now be driven from the top down. Continuing the example of Julie's husband, if John's smart phone is made a part of the larger network, John may receive a call or a text concerning an ongoing promotion. For example, while John is in Target, he may be reminded that he has a gift card for Nike shoes, and that these shoes are one sale on aisle number 6. Or, if John uses his gift card today while he is in the store, he will receive another $5 off Nike shoes.

Such reminders can be relayed either before John enters the store or while John is shopping. If, for example, John is a registered customer of Target such that the Target database includes his cell phone number. If John's phone is activated, based on GPS technology it may be possible to determine what aisle of the Target store John is in. If John is contacted outside of the store, he may be sent a coupon over the phone that says next time you're in Target redeem this coupon and when you spend your gift card you get another $5 off or buy one pair of Nike shoes get another pair half off, or whatever the current promotion might be. As a further alternative, a WAP page may be sent to John's phone with barcode that allows John to redeem an additional value for a purchase if he uses his gift card while in the store.

In accordance with the invention, numerous databases may be linked to a single customer platform ID number, such that when a gift card was purchased on one network, the coding associated with that card may be tracked through to the merchant card (i.e., Target card). The merchant card may be used to interact with a store campaign regardless of who actually purchased and/or used your card, and SKU data acquired through point-of-sale (PUS) technology, which then gets routed through retail network transaction technology, gets pushed back up to the gift card database(s). By virtue of this overall campaign server technology, an end-to-end, real time gift purchasing campaign may be captured from beginning to end with a consumer. The system scored what was purchased, how much was purchased, the day it was purchased, and how the customer responded to the campaign.

The value of the database can also be realized as a result of using the data to draw merchants, as well as CPGs and OEMs into a competitive bidding and/or business environment. If Array knows that, for example, $100 million of unredeemed Array Cards have been activated during a holiday season, it can use that unrealized purchasing power and the information in its database to encourage better deals from merchants, CPGs and OEMs, for both Array and the consumers. This process creates, in effect, a merchant, CPG and OEM auction place where the right to offer coupons, premiums and discounts are competitively bid and/or negotiated, and the results of those offerings can be tracked against historical data.

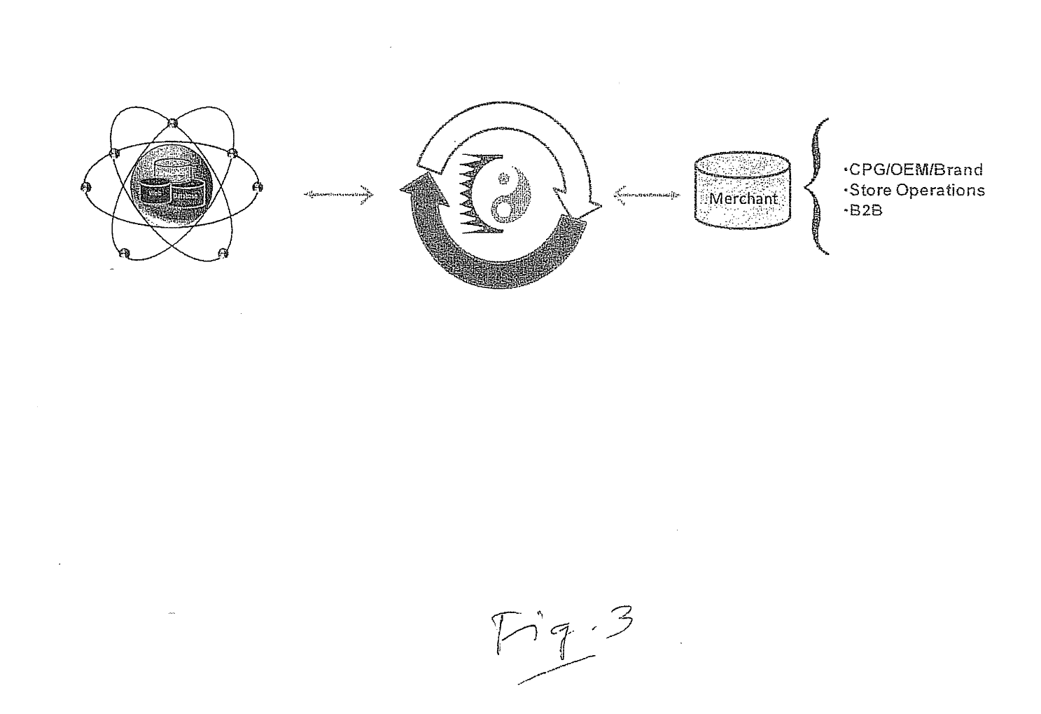

FIG. 4 is a screen display of the Array Card website used by a customer (“Julie”) to sign up for the system. Based upon the information sharing made possible by the invention, Julie may have become aware of the Array gift giving card through social media marketing methods designed to virally attract prospective customers to the website. As with other customers, Julie has the option to register and create a profile without making any purchase, register and make a purchase immediately, or purchase without registering. If she registers, she fills in the various information fields shown in the figure.

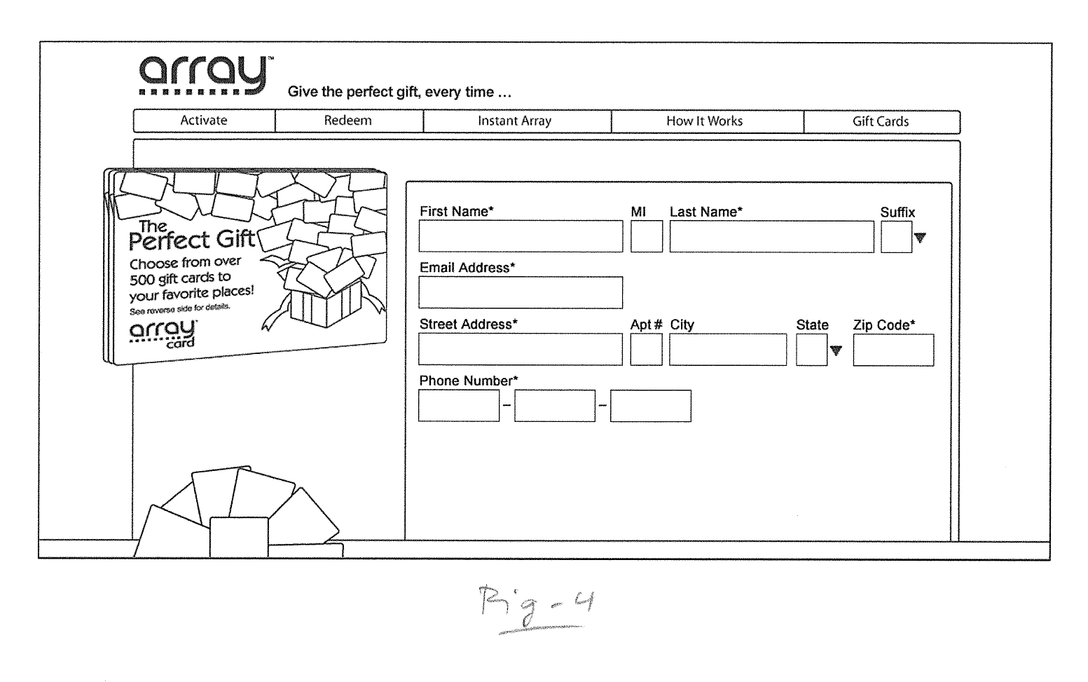

FIG. 5 is a screen display showing the way in which Julie builds her gift network. As shown in the screen display, she can search the system and add new individuals to her gift network with a simple click-through process. She can search external networks, and add new individuals to her gift network using APIs with social networks, email server networks, and other communications capabilities. By searching through friends and family as shown in the figure, they can be invited to become members and participate in the Array process.

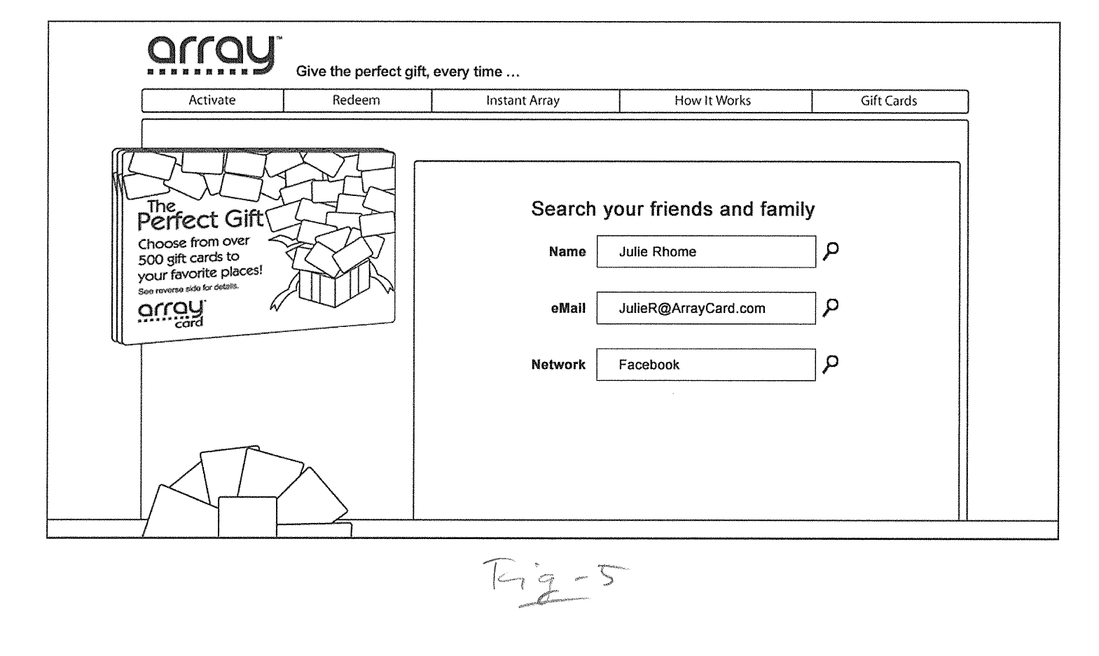

In FIG. 6, the hypothetical customer Julie searches for gift ideas. The interactive customer portal enables product searches based upon information Julie shares about herself and/or her gift recipient(s). Her gift recommendations may be communicated using a case-based reasoning algorithm that dynamically determines personalized selections based on her previously stated profile and/or preferences. Her gift recommendations may be presented in conjunction with a collaborative filtering algorithm that introduces other brands based upon similar shopping habits across a portfolio of “look alike” customers.

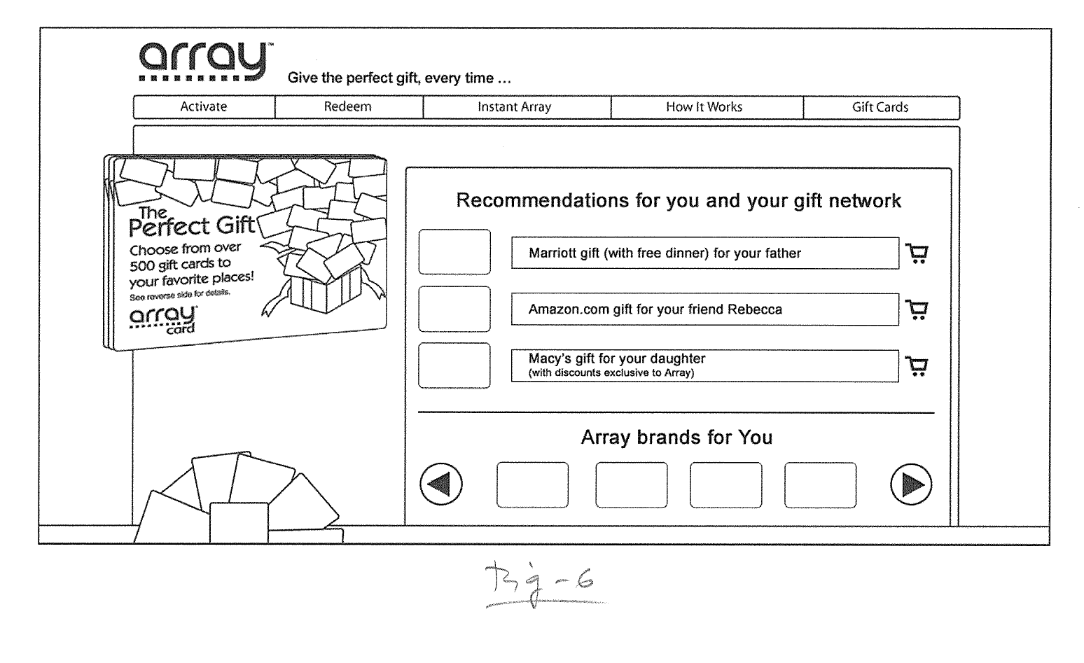

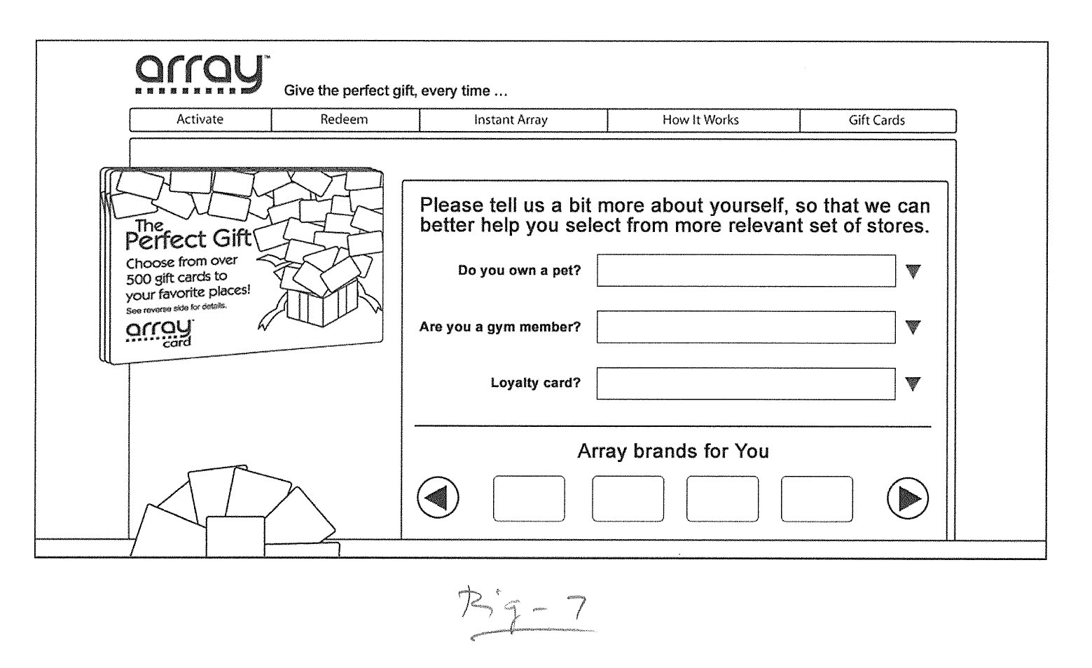

FIG. 7 shows a screen display that provides Julie with a few “golden questions” to obtain further information that may be of benefit to the gifting experience. A customer intelligence engine dynamically develops Julie's profile over time as she shares personal information in responding to these questions. Rather than being intrusive, her answers benefit her by making her shopping task much more easy and enjoyable. A database population technique may be used to ask or a few questions over time thereby enriching Julie's profile in the coming weeks and months. The answers to these questions enable customer portfolio management principles and “ad server” type of data modeling.

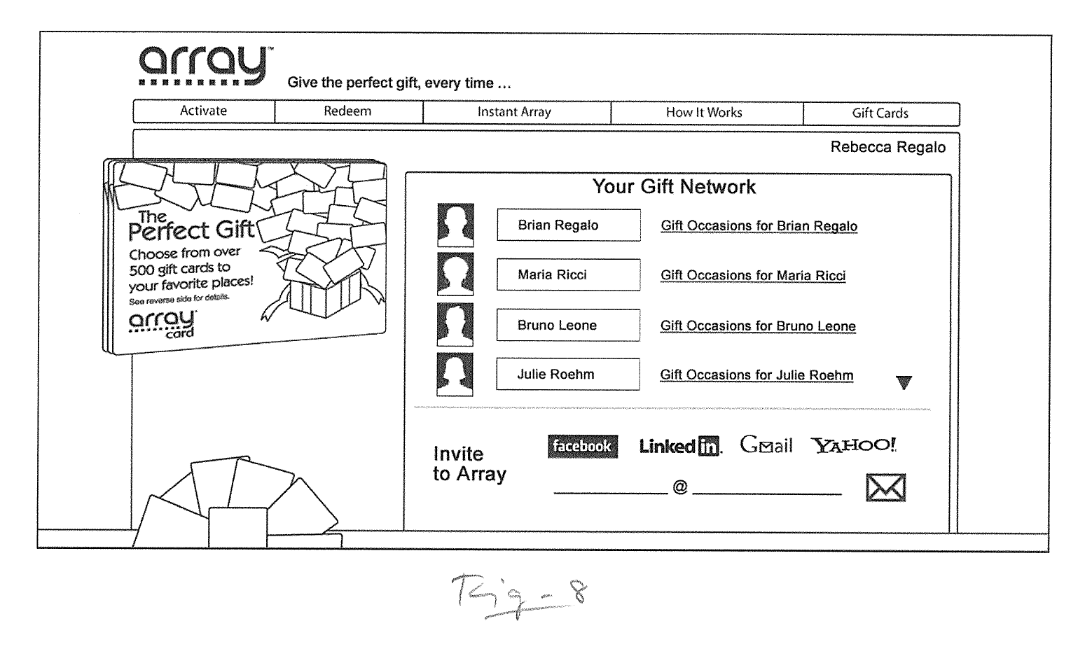

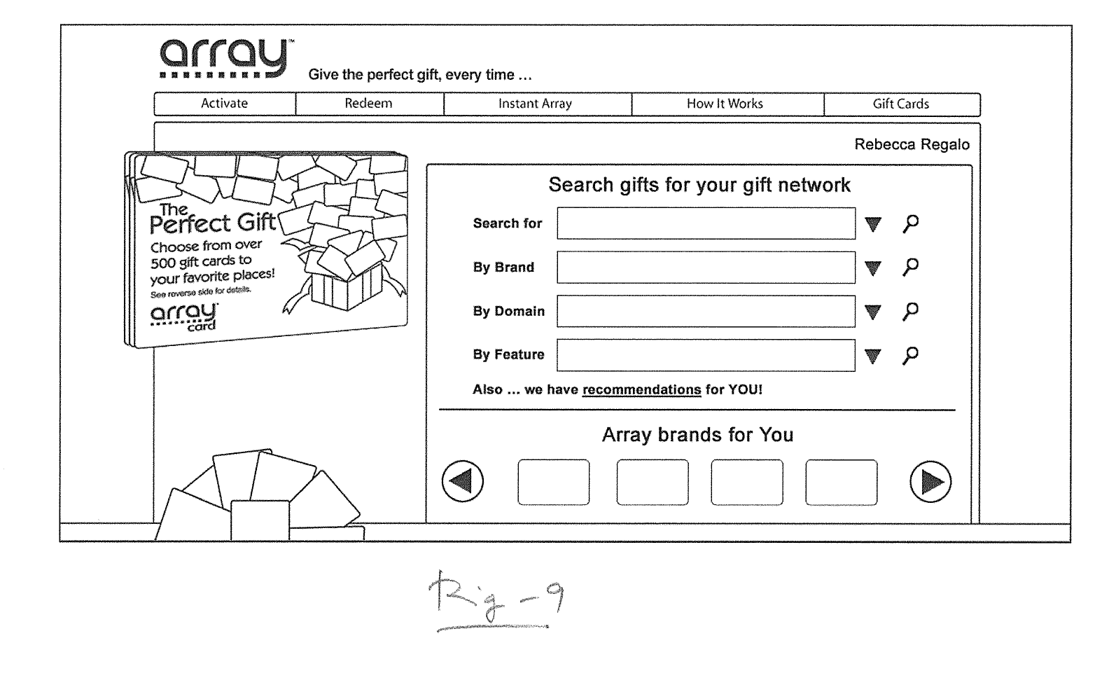

A gift network stimulus is shown in the screen display of FIG. 8. It is assumed that a friend of Julie, Rebecca, has received a gift from Julie. In response to this, Rebecca visits the gift card website and creates an account in order to activate her gift. Now, perhaps without knowing it, Rebecca builds her own gift network. Continuing to FIG. 9, Rebecca decides to perform a gift search for her own gift network. As with Julie, Rebecca has multiple options. She can search gifts for specific individuals in her gift network; she can search by brand, domain, or features; or she can browse through personalized recommendations provided by the gift card website.

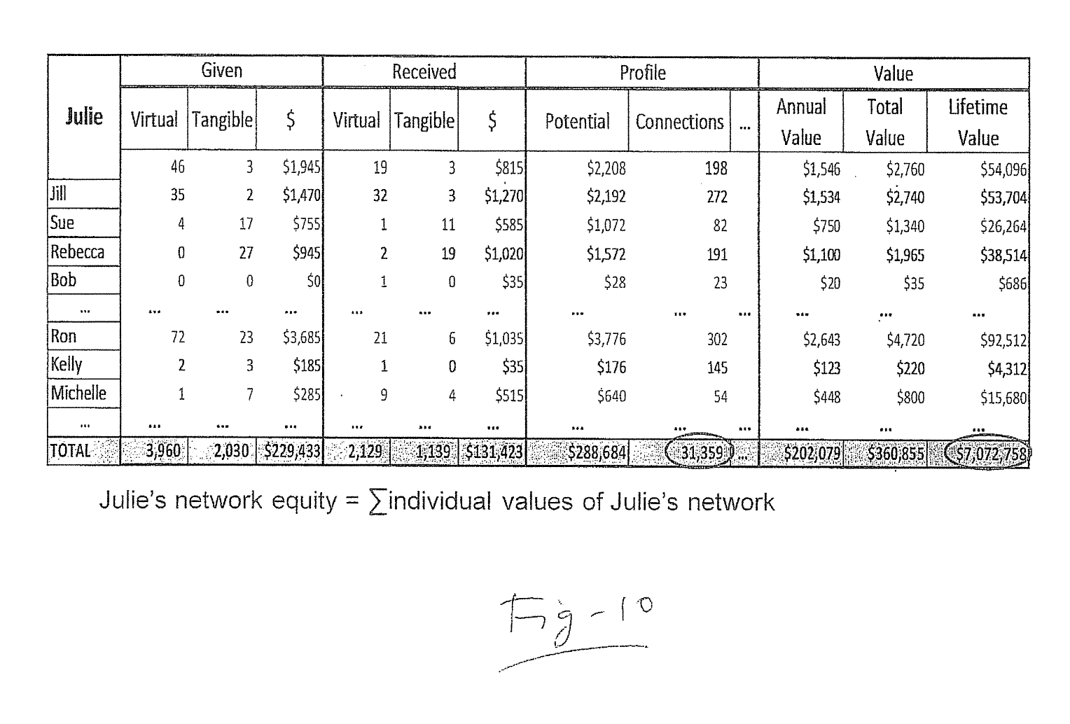

FIG. 10 shows a hypothetical scorecard for Julie's gift network. In contrast to other data acquisition and metric development purchase, a table may be developed involving Julie, her network, and the transactions involved and the individuals associated with her network. Her overall “network equity” may then be determined as a summation of individual values of the various network entries. As shown in the scorecard of FIG. 10, the tabulation involves gifts not only given by Julie, but received by Julie from different persons in her network. Monetary values are also assigned to connections and potential transactions, resulting in annual and total values that lead up to lifetime monetary potentials.

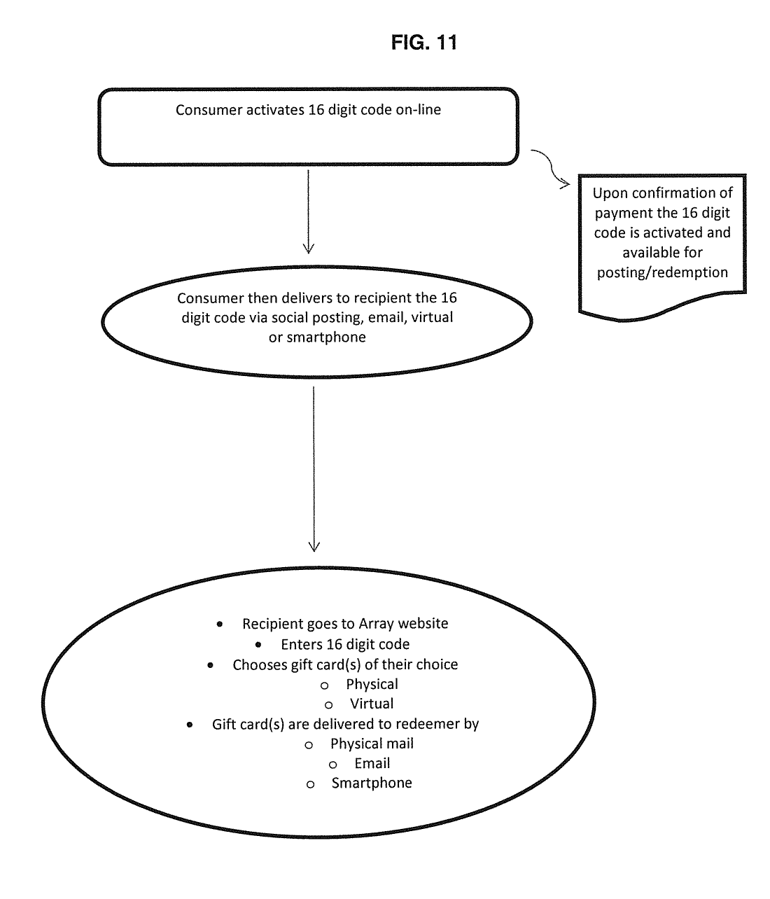

There are numerous ways in which codes may be disseminated, and gift cards distributed, in accordance with the invention. FIG. 11 is a flow diagram that depicts a “social gifting” process flow. In this embodiment, a consumer has the opportunity to purchase and/or activate on-line, at a social network or media site, an Array card or code as a gift. Such a code is preferably at least 16 bits in length to prevent misappropriation. Once purchased/activated, the Array card/code can be delivered/posted to a recipient's social media/network site or emailed or sent via smartphone. The recipient can then link the code to the Array website and redeem for the gift card of their choice (Walmart, Best Buy, Target, Costco, etc.). Array will then deliver to the recipient physically or electronically via first class mail, email or smartphone, their chosen gift card. Once received, the recipient can then go to that brands store and/or web-site and redeem their chosen gift card and/or gift, as the case may be.

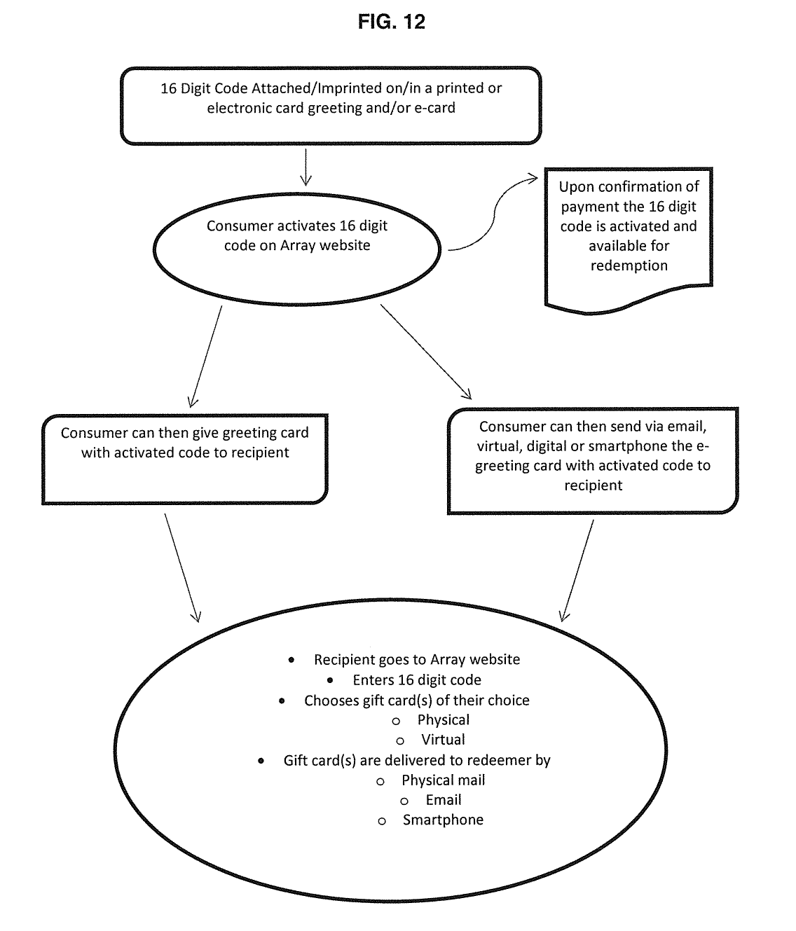

FIG. 12 illustrates a process flow wherein greeting cards are activated on-line. In this embodiment, either a stand-alone or attached or imprinted Array card or Array code will accompany either a printed (hard card) or an e-card/greeting that will allow the buyer of the card/greeting an option to activate the code (again preferably 16 digits) via the Array web-site or link. The 16 digit code can be activated for a choice of denominations. Once activated the card/greeting can be delivered to the recipient as a gift along with the card/greeting. The recipient can then take 16 digit code to the Array website and redeem for the gift card of their choice (Walmart, Best Buy, Target, Costco, etc.). Array will then deliver to the recipient physically or electronically via first class mail, email or smartphone, their chosen gift card. Once received, the recipient can then go to that brands store and/or web-site and redeem their chosen gift card and/or gift, as the case may be.

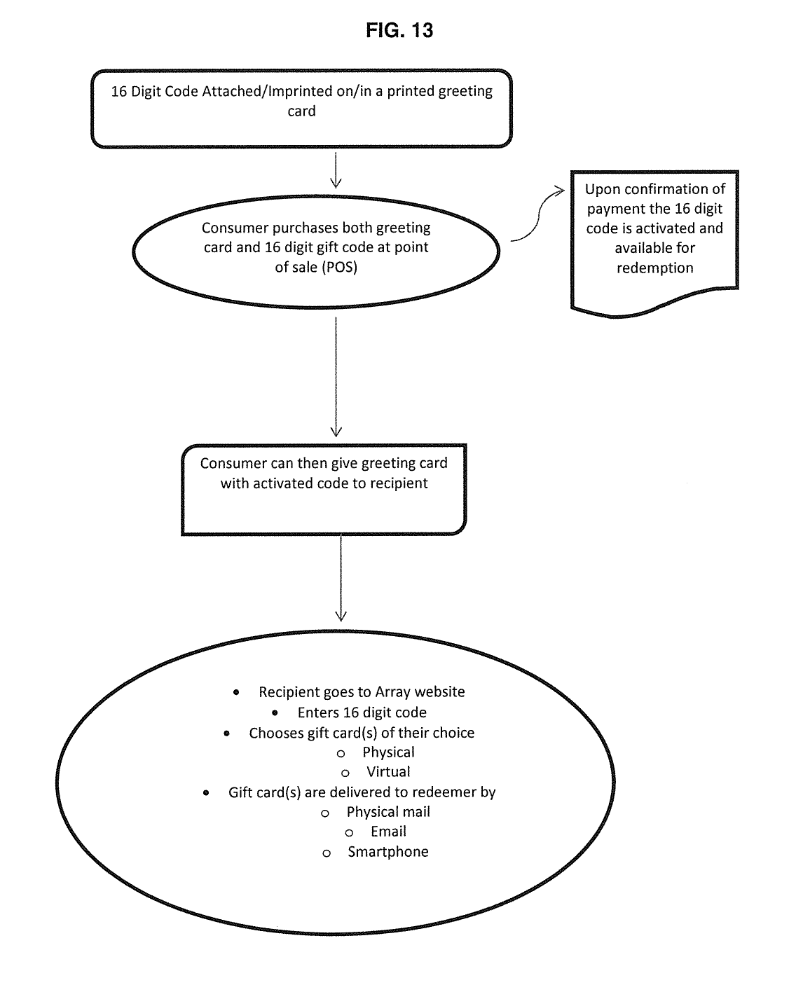

Greeting cards may also be activated at a point-of-sale (POS) location, as depicted in the process flow of FIG. 13. In this case, either an attached or imprinted Array card or Array code will accompany a printed greeting card providing the buyer of the greeting card with the opportunity to purchase both the greeting card and the Array gift card/code in a single transaction at the POS. In order to accomplish this transaction the store's POS communicates with Array's API technology to activate the (16-digit) code. Once purchased/activated at the POS, the greeting card and activated Array card/code can be delivered to the recipient as a gift along with the greeting card. The recipient can then input the code to the Array website and redeem for the gift card of their choice (Walmart, Best Buy, Target, Costco, etc.). Array will then deliver to the recipient physically or electronically via first class mail, email or smartphone, their chosen gift card. Once received, the recipient can then go to that brands store and/or web-site and redeem their chosen gift card and/or gift, as the case may be.

1. A method of enhancing the effectiveness of gift card transactions, comprising the steps of:
establishing a website enabling a user to purchase or activate gift cards for gift recipients;
purchasing a multi-digit code;
activating the code upon confirmation of payment for the code;
transferring the code to a recipient;
entering the code at the website by the recipient, enabling the recipient to receive a gift card having a value corresponding to the payment for the code;
delivering the gift card to the recipient, enabling the recipient to purchase goods or services with the card.

2. The method of claim 1, wherein:
the gift card is physical; and
the card is delivered to the recipient via mail or other courier.

3. The method of claim 1, wherein:
the gift card is electronic; and
the card is delivered to the recipient via electronic mail, smartphone message or other electronic communication.

4. The method of claim 1, wherein the multi-digit code is transferred to the recipient electronically through a social network posting or other Internet communication, electronic mail or messaging to a smartphone or other electronic device.

5. The method of claim 1, wherein the multi-digit code is activated at the website.

6. The method of claim 1, wherein:
the multi-digit code is imprinted on or provide with a physical greeting card;
the code is activated upon purchasing the card; and
the code is transferred to the recipient along with the physical card.

7. The method of claim 1, wherein the gift card is associated with a target redeemer such that the recipient purchase goods or services with the card only form that redeemer.

8. The method of claim 1, wherein the multi-digit code is numeric, alphabetical, or alpha-numeric.

9. The method of claim 1, wherein the code is at least 16 digits in length.
